(19) United States
(12) Patent Application Publication
(10) Pub. No.: US 2012/0042075 A1
(43) Pub. Date: Feb. 16, 2012

(54) ADAPTIVE SERVICES COMMAND AND CONTROL INFRASTRUCTURE

(75) Inventors: Michael C. Goetz, Fort Wayne, IN (US); David C. Holbrook, Fort Wayne, IN (US)

(73) Assignee: Raytheon Company, Waltham, MA (US)

(21) Appl. No.: 12/856,871

(22) Filed: Aug. 16, 2010

(51) Int. Cl. G06F 15/173

(52) U.S. Cl. 709/226

(57) ABSTRACT

A software component that adapts resource utilization to match the needs of operational events in a mobile ad hoc network (MANET) environment such as the military tactical edge is presented. The resources can include network resources and grid computing resources.

### BACKGROUND

Network infrastructure to support operations in a military command and control environment requires high bandwidth, flexibility and robust connectivity. Typically, at the lowest tactical levels (referred to as the “tactical edge”), the network is implemented with a mobile network such as mobile ad hoc network (MANET). A MANET is a highly flexible, self-organizing network of mobile nodes connected by wireless links. It is well suited for military tactical edge communications as it can be operational rapidly and does not need the equipment and logistical support required by networks with centralized control. Tactical MANETs do present problems that can limit their effectiveness, however. Tactical MANET users have to contend with bandwidth constraints and connectivity issues. Also, tactical edge user applications and processing needs may be tied to specific platforms/systems, which can result in a number of inefficiencies. For example, computing throughput may be restricted because of limited available platform resources. Also, even if software default and failover configurations are defined as part of the system design, a load balancing capability across the network may be limited or not supported at all. When the network path to the platform/system cannot be provided or the platform itself is otherwise unavailable, continuity of operations may be impacted.

Prior attempts to improve tactical edge capabilities have tended to focus as separate concerns on either the application software, e.g., services within a service-oriented architecture (SOA) , or the tactical communications capabilities. Addressing the application software and communications as separate concerns limits capabilities available to the tactical edge user and efficiencies in time-constrained operational environments.

### SUMMARY

In one aspect, a method for use by a mobile device operating in a network of mobile devices includes detecting an operational event and adjusting utilization of resources based on requirements of the operational event.

In another aspect, a system includes a mobile user node to connect to other mobile user nodes in a network, and an adaptive services component in the mobile user node. The adaptive services component operates to adjust utilization of resources based upon requirements of an operational event when an operational event is detected.

Embodiments may include one or more of the following features. The resources can include a first type of resources including network resources and a second type of resources including computing resources. A policy may be provided for use in the adjustment of the utilization of resources. The computing resources can be grid-enabled computing resources. The network resources can be mobile ad hoc network (MANET) resources. The MANET can be a tactical edge MANET deployed in a military network environment.

In yet another aspect, a network includes a MANET having nodes and provided with infrastructures to manage resources associated with the nodes. The network further includes an adaptive services infrastructure responsive to the operational events and configured to utilize the infrastructures to adjust utilization of the resources according to requirements of the operational events.

These and other features offer an adaptive services capability to mobile users, for example, tactical edge mobile ad hoc network (MANET) users involved in military operations, for achieving improved performance. To support mission-critical networking applications such as situational awareness, at the tactical edge, the adaptive services capability provides an efficient, mission-focused management of services, computing resources and network resources in a tactical edge network. The resources to support changing operational needs are made available when and where they are needed.

### BRIEF DESCRIPTION OF THE DRAWINGS

The foregoing features of this invention, as well as the invention itself, may be more fully understood from the following description of the drawings in which:

FIG. 1 illustrates an example network environment including a mobile ad hoc network (MANET) of nodes with adaptive services capability;

FIG. 2 illustrates an example network environment in which the MANET (from FIG. 1) is a tactical edge MANET connected to a command outpost network via a wide area network;

FIG. 3 illustrates an example architecture for a tactical edge MANET (like that shown in FIG. 2) with an adaptive services command and control infrastructure (ASCCI);

FIG. 4 illustrates an example architecture of a device configured as a MANET node having ASCCI middleware;

FIG. 5 illustrates an example operation involving the ASCCI middleware (from FIG. 4); and

FIG. 6 illustrates example inputs/outputs of the ASCCI (from FIGS. 3-5).

### DETAILED DESCRIPTION

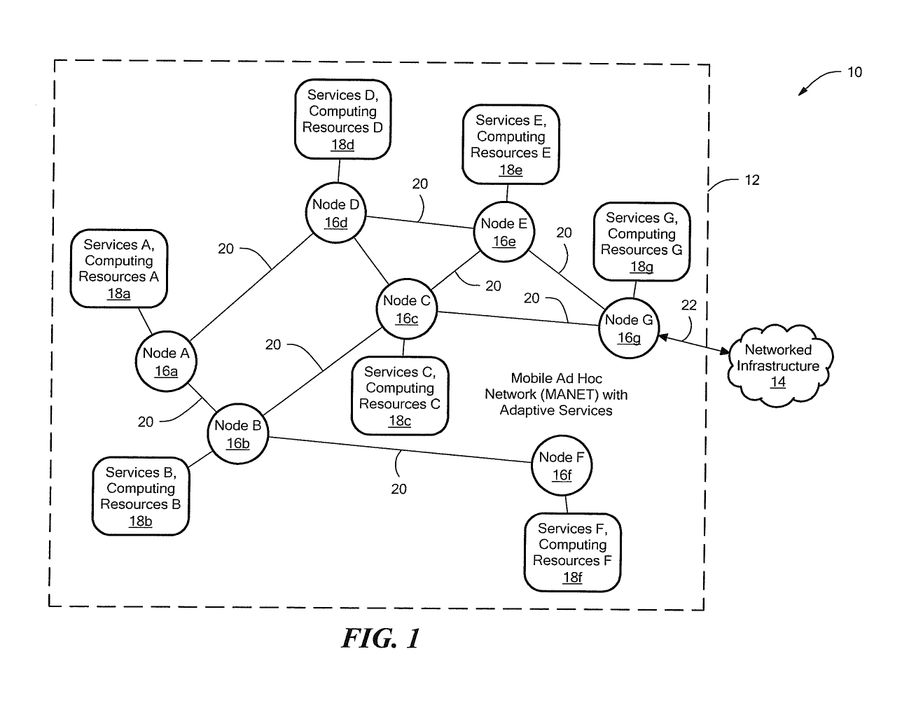

Referring to FIG. 1, a network environment 10 to support operations (e.g., tactical edge operations) of an organization includes a mobile user network 12 connected to other networks. The other networks are represented collectively as a networked infrastructure 14. In one exemplary embodiment, as illustrated, the mobile user network 12 is configured as a Mobile Ad Hoc Network (MANET). In another exemplary embodiment, the mobile user network 12 maybe provided as a tactical edge MANET. Thus, network 12 may be a military or non-military network.

A MANET has a self-adjusting and ever-changing topology, with mobile nodes joining and exiting the network over time based on proximity of node to node. Thus, for purposes of illustration only, the MANET 12 is depicted at a particular point in time as including some number of nodes. The MANET 12 is shown here to include node 16a (“Node A”), node 16b (“Node B”), node 16c (“Node C”), node 16d (“Node D”), node 16e (“Node E”), node 16f (“Node F”) and node 16g (“Node G”), generally denoted nodes 16.

Services and computing resources are associated with the nodes 16 in the MANET 12. In the illustrated example, services and computing resources (“Services A, Computing Resources A”) 18a are associated with node 16a, services and computing resources (“Services B, Computing Resources B”) 18b are associated with node 16b, services and computing resources (Services C, Computing Resources C”) 18c are associated with node 16c, services and computing resources (“Services D, Computing Resources D”) 18d are associated with node 16d, services and computing resources (“Services E, Computing Resources E”) 18e are associated with node 16e, services and computing resources (“Services F, Computing Resources F”) 18f are associated with node 16f, and services and computing resources (“Services G, Computing Resources G”) 18g are associated with node 16g. The services associated with the nodes 16 are organized and managed according to a service-oriented architecture (SOA). The computing resources available at the nodes 16 are managed according to a grid computing architecture.

Still referring to FIG. 1, the nodes 16 are interconnected to neighboring nodes by wireless links 20. Each of nodes 16a-16f are configured to serve as host (end user) and router. At least one node, shown as node 16g, is implemented to connect the MANET 12 to the networked infrastructure 14 via a wired or wireless connection 22. The networked infrastructure 14 can include any combination of terrestrial wired, fixed wireless, satellite, mobile wireless and mobile ad hoc networks.

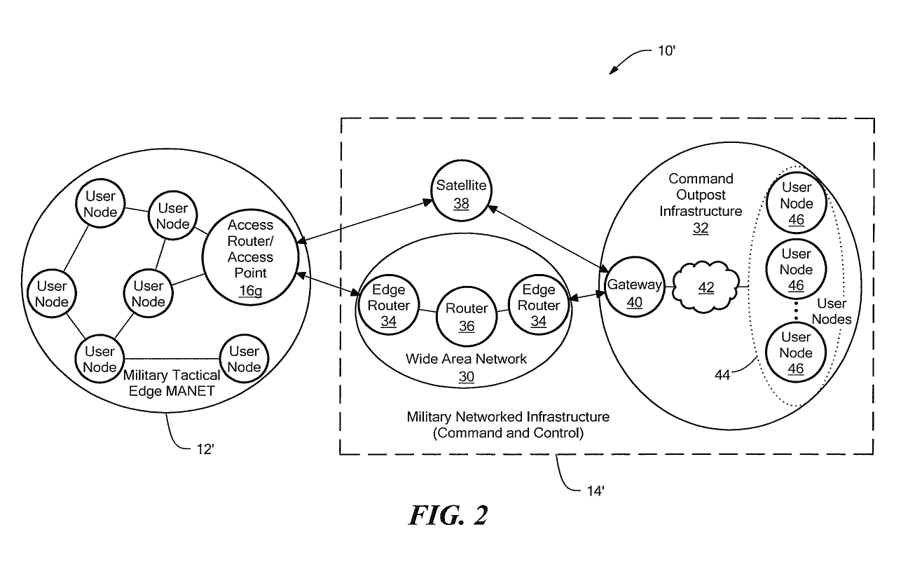

Referring to FIG. 2, in one exemplary embodiment, the network environment 10 from FIG. 1 is a military network environment, indicated by reference numeral 10′. The network environment 10′ enables a chain of communications from tactical edge users to higher echelon users of the military enterprise. In the network environment 10′, the MANET 12 from FIG. 1 is provided as a military tactical edge MANET, shown in FIG. 2 as a military tactical edge MANET 12′ (referred to hereinafter as “MANET 12′”). The military command and control structure of the network environment 10′ uses the MANET 12′ to establish data and communication links, distribute situational awareness information, and integrate/fuse information with other relevant information to create a broader operational picture of the battlefield.

Still referring to FIG. 2, and according to one example implementation, the network environment 10′ includes at least three subnets. The at least three subnets shown in FIG. 2 include the MANET 12′, an intermediate (or transit) wide area network 30 and a command outpost network or infrastructure 32. Most of the nodes in the MANET 12′ are mobile “user” nodes that correspond to devices carried or worn by tactical edge military personnel (e.g., combat troops or medics), or systems located in ground-based vehicles or aircraft. Although those nodes can serve as both ad-hoc routers and end users, as mentioned earlier, other network arrangements are possible. Unlike a standalone MANET, in which all of the nodes are end user nodes, the MANET 12′ has at least one node that is configured as an access router/access point. In the illustrated example, that node is node 16g. The access router/access point 16g connects the MANET 12′ to the rest of the infrastructure. The intermediate WAN 30 includes edge routers 34 and one (or more) intermediate routers 36. Also shown as part of the networked infrastructure 10′ is a satellite 38. The command outpost network 32 includes an access router (with secure gateway and satellite capability) 40 that connects either directly or indirectly (via network “cloud” 42) to an end user network 44 or group of end user nodes 46. The router/gateway 40 can provide satellite communications reach back or fixed network connectivity for the tactical MANET 12′. Thus, the mobile nodes 16 that connect to form the MANET 12′ can connect to the command outpost network 32 by satellite links or by the WAN infrastructure.

Although only three subnets are shown, it will be appreciated that the network environment 10′ could include other subnets and the specific configuration of the subnets may vary. For example, the MANET 12′ could be connected to one or more other MANETs. In a tactical environment, a MANET node such as MANET node 16 in MANET 12′ may connect to and receive input (e.g., audio, video, images, motion data and the like) from a variety of sources, including sensors or sensor networks, as well.

Referring to FIGS. 1-2, the nodes 16 represent computing/communication devices that can operate in a MANET environment, such as laptops, handheld devices such as PDAs, phones, wearable computers and other mobile devices. The devices are wireless, using network medium(s) or transfer mechanism(s) based on a wireless network protocols technology such as radio (e.g., software defined radio, cognitive radio, multiple input multiple output), Bluetooth, ZigBee (IEEE 802.15.4), Ultra-WideBand or WiFi (IEEE 802.11), among others, or perhaps a combination of one or more such technologies. It will be understood that each device associated with a particular user will be configured with the appropriate interface and software to implement the communications protocols used by that device. It will be appreciated that the devices may be the same or different, for example, user node 16a could be a handheld device while node 16d could be a laptop computer. The networked infrastructure 14 can include a homogeneous or heterogeneous network environment, as mentioned above, with various types of network equipment, media and protocols supported. As was shown in FIG. 2 with networked infrastructure 14′, the networked infrastructure 14 from FIG. 1 can correspond to military networked infrastructure (for military command and control).

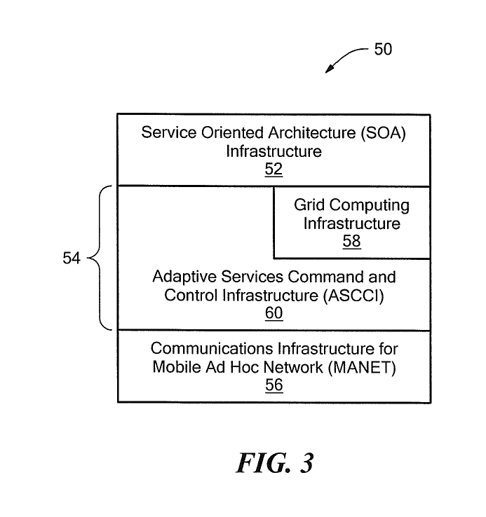

As shown in FIG. 3, a MANET with adaptive services, which may be the same as or similar to MANET 12 (in FIG. 1) or MANET 12′ (in FIG. 2), has a layered architecture 50 that includes an SOA infrastructure 52, a middle layer infrastructure 54 and communications infrastructure 56. The middle layer infrastructure 54 includes a grid computing infrastructure 58 and an adaptive services infrastructure or component shown as an adaptive services command and control infrastructure (“ASCCI”) 60. Although “ASCCI” incorporates the term “command and control” typically associated with the military, it will be understood that the ASCCI 60 is intended to represent an infrastructure applicable not only to military tactical command and control operations in a military organization but to command and control (or like) functions of a non-military organization, e.g., public safety forces or disaster relief forces/teams, or commercial enterprises. In a MANET protocol stack based on the layered architecture of the Open Systems Interconnection (OSI) reference model (minus the session and presentation layers) or Internet Protocol suite, the SOA and middle layer infrastructures (infrastructures 52, 54) would reside at the application layer and the communications infrastructure 56 represents protocols that would reside at or be distributed across lower layers.

The SOA infrastructure 52 manages available services according to a set of common standards, rules, security policy and a common shared infrastructure. The services are software units that can be invoked by the service consumer, that is, the user node that uses the service. Applications such as command and control applications are constructed from the services according to workflow and policy mechanisms of the SOA. The services are reused by and shared between different applications. The command and control applications in tactical networks include real-time services such as Voice-Over-IP, streaming video, real-time messaging and other time-sensitive tactical applications that require stringent QoS guarantees with limited computing and network resources. In accordance with the SOA infrastructure 52, the nodes 16 exchange information (e.g., service description information) to enable discovery and use of the services. Implementations of SOAs can follow different approaches, for example, they can be Web-based using Hypertext Transfer Protocol (HTTP) for communications protocol, Simple Object Access Protocol (SOAP) for exchanging messages, Web Services Description Language (WSDL) for describing Web services and Universal Description, Discovery and Integration (UDDI) for registering services.

In addition to services, the nodes 16 share information about available and accessible computing resources. The grid computing infrastructure 58 manages, that is, adjusts the utilization of the services by the computing resources. The computing resources can include such resources as CPUs, CPU processing power or available CPU cycles. In some embodiments, the computing resources impacted by the grid computing infrastructure 58 may include storage capacity as well. The computing resources are fixed, and are limited by the devices that are available for processing. As a result, effective and continuingly complete utilization of the computing resources leads to the need for some way to monitor, manage, and adjust this utilization, which in turns leads to a grid computing approach. As with the services, the nodes each construct a repository for storing information about the available computing resources. The grid computing infrastructure 58 provides a framework in which the SOA-based services discover, allocate, schedule and monitor access to computing resources over time. Effectively, the grid computing infrastructure 58 enables the sharing, selection and aggregation of computing resources distributed across organizational, functional and geographic domains. Security concerns are addressed using a policy-based approach, so that the grid computing infrastructure 58 ensures that only the nodes that make up the defined grid (that is, implement the grid computing infrastructure 58) can access the grid resources.

The communications infrastructure 56 manages network resources, such as network connectivity and bandwidth. The ability to allocate bandwidth based on conditions, policies and priorities, and to provide routing alternatives are key features of the communications infrastructure 56. Various types of information, including multimedia, video and data, may be supported by the communications infrastructure 56. The nodes 16 share information about the network topology and accessible network resources to build up a network resources repository. The network resources repository includes information about a node and the MANET, e.g., available bandwidth, link characteristics, available nodes and node activity.

The communications infrastructure 56 performs network routing through dynamically changing (mobile) networks and node-wise management of links for network routing. Route determination latency and routing table storage (and maintenance) drive protocol selection in the absence of the ASCCI 60 at the node level. As security is a critical issue at the network level as well, the communications infrastructure 56 operates via policy mechanisms to allow only appropriate connections to exist.

When nodes join or form a MANET, for example, when they move spatially or switch on their wireless interface, they are able to reach neighboring nodes and construct an ad-hoc mesh. After performing link discovery and other operations necessary for automatic configuration, SOA and grid computing functionality is constructed. The resource nodes 16 send information about their services and resources into the network so that those services and resources are visible to other nodes. Each node stores configuration information concerning availability of the resources and its own use of resources. All of the information necessary for exchanging messages between service/resource provider and service/resource consumer when a node wishes to use another node's service or resource is contained in the stored configurations (which may be implemented in tables or other data structures). For example, each service is represented by a data structure containing service elements, including the service description and a validity time, and the service description includes the service name, address, protocol (to be used to access the service) and description. The messages/exchanges are routed to the appropriate node via the lower-layer ad-hoc routing protocol. The ad-hoc routing protocol is also used to discover neighboring nodes and set up routes. Since MANETs support mobility, information about routes and topology is constantly updated.

The ASCCI 60 allows a node such as a tactical edge node to automatically tune node performance by making adjustments in one or more of the foregoing infrastructure areas, that is, services, computing resources and communications, based on operational needs, as will be described in further detail later. For example, the ASCCI 60 can use controls in the network protocols of the communications infrastructure 56 to choose a best path for routing and best radio frequency to use to efficiently support the user. Through the use of the ASCCI 60, each MANET node can optimize itself to achieve a better performance, e.g., with increased bandwidth, for a given operational event. The overall architecture allows processing of services software (available in the SOA infrastructure 52) on particular computer resources in the grid computing infrastructure 58 based on connectivity established by the communications infrastructure 56.

The term “operational event”, as it is used herein, refers to a change in the operational environment. Operational events will generally be detected and determined by command and control application software (and at times by the MANET), and used to initiate optimizations for the services, computing resources, and communications. For example, an operational event such as an “ambush of a tactical unit” would be expected to lead to optimizations which preclude or limit severely near-term updates for logistics and supply capabilities.

The ASCCI 60 is service, computing and network resource adaptive. It is service adaptive in the way it utilizes the SOA infrastructure 52 to provide service discovery, workflow and service/workflow configurability to complete prioritized activities. Its ability to adapt services to the available computing resources involves the use of the grid computing infrastructure 58 to manage and prioritize computing resources to provide high Quality-of-Service (QoS) for the highest priority activities. The ASCCI 60 is adaptive with respect to network resources in that it uses the communications infrastructure 56 to identify, maintain and manage end-to-end network links for communications. The ASCCI 60 uses control logic that exists in each of these infrastructures to achieve optimizations appropriate to specific operational needs. With this overall architecture, an operator at a mobile node such as node 16a (FIG. 1) can perform priority activities in the most efficient manner possible using SOA workflows/services without regard for how the grid infrastructure controls computing resources or how the network is configured to achieve the necessary high-bandwidth communication links. For example, in a tactical edge command and control environment, the ASCCI may determine that a command and control application with a combat engineering focus must be resource limited in order to prosecute fires against an immediate threat or a highly important target of opportunity, the information for which is being made available from a different MANET—capable node.

The ASCCI 60 may be used in any environment in which a mobile user is resource limited (e.g., a mobile user at the “tactical edge”) and does not want to manually adjust system level parameters during times of greatest operational load. The ASCCI 60 provides a mechanism for dynamically allocating and managing network resources based on operational load. The ASCCI 60 can also adjust the utilization (including at other locations and with variable availability) of computing resources to ensure that an operator's high priority capabilities are maintained. An operator priority for service, computing resources, and network communications will be set based upon a guidance or policy mechanism, so that the ASCCI can be automated and nearly seamless to the operator. The inclusion of the ASCCI 60 in a resource-constrained mobile user network environment such as a tactical network environment serves to separate applications (such as tactical command and control applications) that utilize the SOA from the grid computing capabilities that scavenge available processing resources and further separates the network capabilities of the MANET through an adaptive, comprehensive, policy-based infrastructure.

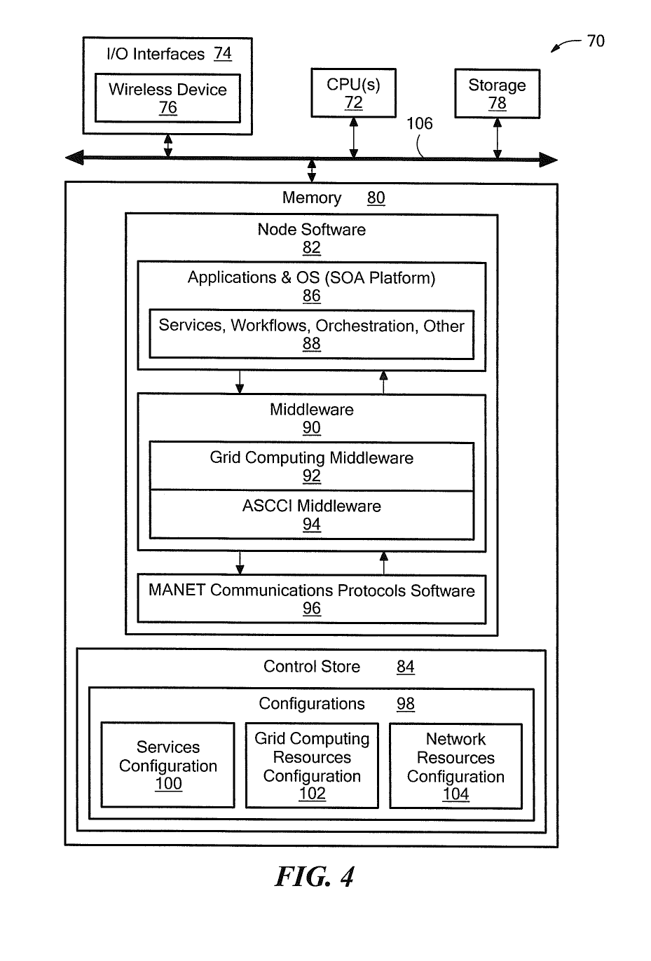

FIG. 4 shows a simplified, example architecture of a device 70 that can be used as a MANET node with the adaptive services (i.e., ASCCI) capability. In a very basic configuration, the device 70 includes at least one processing device, for example, one or more processors (e.g., CPUs) 72. The processor 72 executes instructions of software and processes data received by the device 70. Also included are various interfaces, including I/O interfaces 74 such as network hardware or communication interface 76 (e.g., wireless device, such as radio). Other interfaces such as input device(s), e.g., data entry interface such as keys, mouse, touch panels, voice input device, etc., and output device(s), e.g., display, speakers, etc. (not shown) would be included as well. The I/O interfaces can also include interfaces that enable transfer of software and/or data to the device from external (removable) computer readable media or from the device to such media. Internally, the device 70 is provided with computer readable media in the form of storage 78 (e.g., hard disk storage) and memory 80 including nonvolative memory to store software 82 and a control store 84. The software 82 includes applications and operating system (OS) that are SOA platform based (indicated by reference numeral 86). The SOA platform 86 includes services, workflows, orchestration and other SOA software components 88. The software 82 further includes middleware 90 including grid computing middleware 92 and ASCCI middleware 94. Also included as part of the software 92 are MANET communications protocols software 96, which are used to support network communications in the MANET. The software 82 is copied to the memory 80 (or internal processor memory) from the storage 78 or an external source for subsequent execution by the processor 72.

The control store 84 stores configurations 98 constructed and maintained by the various applications and other software. These configurations 98 include a services configuration 100, a computing resources configuration 102 and a network resources configuration 104. The services configuration 100 includes, for example, service tables with service descriptions maintained according to the SOA. The computing resources configuration 102 includes tables or other data structures to identify available and accessible computing resources. The information contained in the computing resources configuration 102 is maintained by the grid computing middleware 92. The network resources configuration 104 provides information about the network, e.g., network topology (such as available nodes and links), routing information, bandwidth, QoS and network prioritization.

The device 70 may have additional features or functionality as well. The various functional blocks of the device 70 are coupled to an internal bus structure, shown here in simplified form as interconnect 106.

In response to a change in the operational environment, that is, an operational event, the ASCCI software 94 takes advantage of the knowledge of the various infrastructures to optimize the node's configurations based on application needs at any point in time. It determines if a change to utilization of network resources or computing resources (or both types of resources) is appropriate based on the type of operational event.

In a military command and control environment at the tactical edge, instances of an operational event during the course of battle lead to commander-driven / policy-driven needs to effect command and control tasks based upon the operational event, which may generate response adjustments to network resources (such as changes to bandwidth/throughput) or to the computing resources. Command and control operational events at the tactical edge can include the needs to obtain/view video for a particular battle area, to react to an imminent threat or to secure a swift response to a request for fire support, to give but a few examples.

In the case of video, a soldier/user operating at a MANET node may determine that he needs to view or send a particular video for a specific battle area. The need for video is an operational event that requires a significant amount of bandwidth and therefore impacts network loading (i.e., network bandwidth utilization), requires specific services for viewing and data storage, and leads to adjustments in the utilization of the computing resources to ensure that the high priority task (video) can proceed without disruption.

The ASCCI middleware 94, responsive to the network loading change, sends information to the communications infrastructure control logic that causes it to implement a higher priority bias on network connectivity and throughput to the node (or nodes) associated with that battle area so that the video can be obtained or sent upstream as needed. Thus, the ASCCI middleware 94 takes advantage of the control logic of the communications protocols software 96 to bias communications infrastructure (in terms of bandwidth, connectivity, throughput, priority and so forth) towards the operational needs at any given time.

The ASCCI middleware 94, responsive also (e.g., as a follow-up) for the needs of the video software, sends information which modifies how the service software will be allocated to the available computing resources. For example, a new instance of the video software may need to be started on the node, with computing resources retrieved from services that previously had the highest priority and complete use of available resources. The ASCCI middleware 94 works to bias the use of computing resources via the grid computing middleware 92 to locations within the established network topology where processing resources can be utilized more efficiently. For example, and briefly referring back to FIG. 1, the ASCCI middleware 94 at node 16a may determine that an application at that node may be processed more efficiently using a computing resource at node 16g instead of node 16a (or some other previously assigned node), perhaps due to a higher bit rate route available to the node 16g which is not available to node 16a. This change requires an update in route (between the new endpoints of its communications) as well as changes to the software.

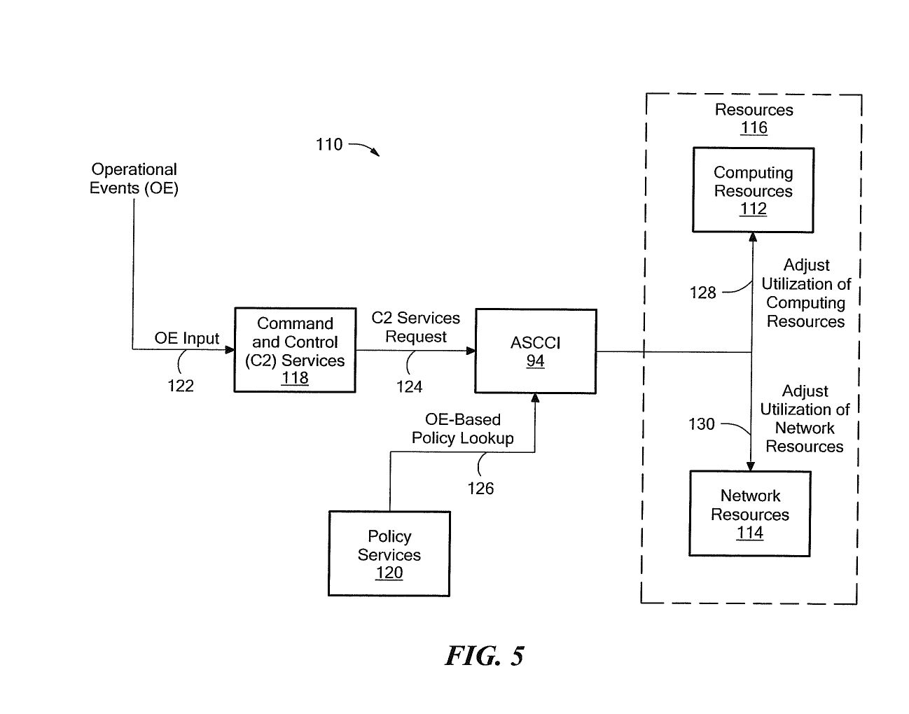

FIG. 5 is a functional overview of an exemplary operation 110 in which the ASCCI middleware 94 (from FIG. 4) is used to adjust utilization of resources when operational events occur. The types of resources that can be adjusted include computing resources 112, and the services and control mechanisms for the computing resources, and network resources 114, collectively resources 116. The computing resources may be grid-controlled computing resources when a grid computing infrastructure is used to monitor the availability of computing resources such as CPU, and control the operation of services to optimize use of the computing resources. The illustrative operation 110 involves several functional components of the system. In addition to the ASCCI 94, the operation 110 also utilizes services of the SOA, including command and control (or “C2”) services 118 and policy services 120. To begin, an operational event occurs within the area of interest for the operation, and is detected by the command and control services 118. Detection occurs when an operational event input (input 122) is received by the command and control services 118. In response to the operational event input, the command and control services 118 sends to the ASCCI middleware 94 a request/notification for modifications to the overall utilization of the resources 116, that is, the computing resources 112 and the network resources 114 (C2 request 124). The operation of the command and control services may occur with the involvement of the user, or may be an automated capability. The C2 request (or notification) 124 conveys to the ASCCI middleware 94 the nature of the operational event (e.g., type of operational event) and an indication that adjustments are needed within the resources 116. The ASCCI middleware 94 performs a policy lookup 126 against policy provided by the policy services 120. Based on the results of that lookup, the ASCCI middleware 94 determines which resources are to be adjusted and initiates the required adjustment(s), that is, it initiates the adjustments of the utilization of computing resources (as indicated by reference numeral 128) and/or the network resources (as indicated by reference numeral 130). Individual policies (which can include guidances, for military uses) within the policy services 120 specify, for different types of operational events, which kinds of resource adjustment actions should be taken and how/when they should be taken. Specific policies will be defined for commonly occurring operational events, but specific policies may be unavailable for certain types of operational events. The policy services may be configured to provide a default policy for use when a specific policy is not available, or the ASCCI middleware 94 may be implemented to consult the operator/user for further instruction if no policy or default policy can be found.

In general, small initial changes are made to adjust the use of the computing resources or to the network resources, but not both concurrently. In one exemplary embodiment, a policy provided by the policy services 120 is used to determine which of the resource types (computing or network) to modify first, when to make changes to the second instead, and the conditions under which a combined approach (modification to both types of resources, i.e., changes to computing resources followed by changes to network resources, or vice versa) should occur. For example, a detection of a specific threat on the battle field may lead initially to adjustments in utilization of the computing resources 112 (including starving resources to less-critical applications), then to adjustments to network resources 114, e.g., to adjust bandwidth and/or throughput.

Thus, in one embodiment, the general precedence of decisions for the ASCCI middleware 94 is dictated by policy provided by the policy services 120. Different approaches such as a prioritized approach to determining which resource type to change, or a combined approach based upon an algorithmic approach, can be used. The use of a non-policy based approach to the ASCCI decision making, including a manual approach which uses operator decisions in lieu of policy, is also possible.

Network resources may be modified in order to respond to an operational event. This modification can involve adjusting QoS and network prioritization, selecting a more optimal route or taking any other action(s) that could result in an increase in bandwidth and/or throughput to the application. For example, a selection of a more optimal route (for increased bandwidth) between two node endpoints may be made by changing connectivity in the network. In a different example, a selection of a more optimal route (for increased bandwidth) may be achieved by adapting the endpoints to the known topology (i.e., changing the node endpoints by moving a service or services from one endpoint node to a different node), so as to move a high processing burden closer to the source of data, and to allow the processing results, rather than large amounts of unprocessed data, to be forwarded over limited bandwidth connections. It can be appreciated from these and other examples that adjusting the network resources can involve a change to services as well. Changes to QoS at the node level may involve changes to congestion management, queue management, link efficiency and traffic shaping. Network prioritization classifies and prioritizes traffic based on application type (voice, video, etc.), type of user or other types of classifications. To adjust the network resources, the ASCCI middleware 94 communicates the required modification to control logic in the communications protocols software 116 (from FIG. 4), which implements the changes, e.g., updates the resources configuration and other information, and applies the updates to the wireless interface. As one example, the ASCCI middleware 94 could modify the selection or rules by which a hybrid MANET algorithm scheme determines the relative priority and transition of one protocol (e.g., a table-driven MANET protocol) to another (e.g., a request-driven MANET protocol).

The computing resources adjustment can involve adjusting node and/or network configurations to re-allocate services to alternate computing resources. Adjusting the available computing resources is likely to involve in addition a change to services, e.g., service startups, service shutdowns, and service re-deployments from one node to another.

Most computing systems will run slowly with delays when multiple applications are attempting to run at the same time. The grid system also senses when resources are scarce, and adjusts the use of resources by its grid-enabled applications to the minimum required to allow “normal operation”.

In addition, in an adaptive services environment as described herein, selected grid-enabled services can be configured to automatically adjust either to resource needs at a particular node or to commands from another node to limit or increase the use of available computing resources. Thus, the service configuration may be modified to limit (or shut down) low priority services while maintaining high priority services. The grid computing infrastructure provides the control of computing resources, including whether certain selected “grid enabled” services can be given all the resources needed, or if the same services must be “resource starved”. The SOA infrastructure prevents the changes to application services from affecting other services in the SOA. This control need not be limited to one node, but may be global based upon policy. Preferably, the smallest possible number of nodes would be encompassed in these decisions; however, the number of nodes under consideration could scale up based upon the nature and criticality of the operational event.

Applications or services that are “grid-enabled” can react in a controlled manner to “get out of the way” when full use of computing resources by other applications is needed. As an example, consider a grid-enabled supply logistics application in a tactical command and control environment. A grid-enabled supply logistics application running on a particular node can fully use the network and computing resources until another application, for example, a fires application, must become a priority on that node. The loss of the logistics processing on one node generally means that the data and the processing flow on that node must transition to another node, and the communications infrastructure will need to be involved to ensure that the transition occurs seamlessly.

More than one node may detect the same operational event. For example, the C2 services of two nodes in close proximity to the same operational event may detect the event. Thus, each node that supports the adaptive services capability will be configured with arbitration logic to resolve potentially conflicting detections/responses. Examples of suitable arbitration approaches include, and are not limited to, “first wins” and voting logic between the peer nodes.

Still referring to FIG. 5, one example usage scenario that further illustrates the operation of the ASCCI middleware 94 operation is as follows. An ambush occurs as the “operational event” and is detected by the command and control services (at input 122). The command and control services 118 notifies the ASCCI middleware 94 that the ASCCI middleware 94 will need to modify the network and computing resources to deal with the operational event. For this type of operational event, the ASCCI middleware 94 determines using a policy from the policy services 120 that the use of computing resources for non-essential capabilities (e.g., maintenance operations, supply operations) in the area of the operational event should be limited and that the use of computing resources for essential capabilities (e.g., fires, air support) in that area should be increased. The ASCCI middleware 94 adjusts the use of the computing resources in accordance with the policy. The ASCCI middleware 94 does not adjust network resources at this point. As the battle progress, other operational events drive changes to network resources based upon policy. Examples of changes to network resources could include changes to the underpinning MANET algorithms for next node determination, or could involve addition of communicating nodes to the network.

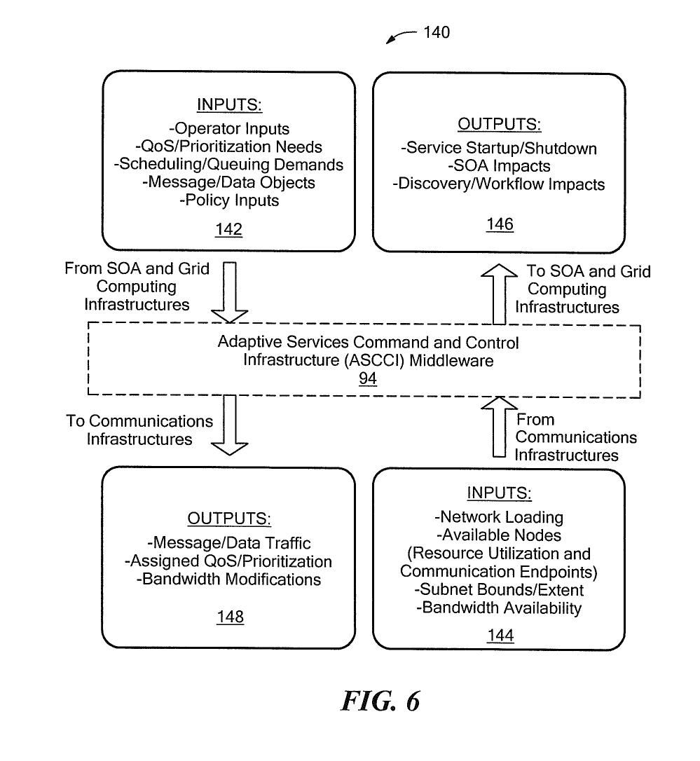

FIG. 6 shows the ASCCI middleware 94 inputs and outputs 140 according to one exemplary embodiment. On the SOA and grid computing side, a first set of ASCCI inputs 142 includes: operator inputs; QoS and prioritization needs; scheduling and queuing demands; message and data objects; and policy inputs. On the communications infrastructure side, a second set of ASCCI inputs 144 includes: network loading; available nodes (resource utilization and communication endpoints); subnet bounds and extent; and bandwidth availability. Also on the SOA and grid computing side, a first set of ASCCI outputs 146 includes: service start-up and shutdown; SOA infrastructure impacts; and discovery/workflow impacts. The interface between the ASCCI middleware 94 and communications infrastructure 56 has a second set of outputs 148. The second set of ASCCI outputs 148 includes: message and data traffic; assigned QoS and prioritization and multimedia bandwidth modifications. For a given set of inputs and outputs (e.g., inputs 142, 144 and outputs 146, 148) the ASCCI middleware 94 provides policy-based resource management and security.

Some of the inputs 142 the ASCCI receives from the SOA and grid computing side directly relate to a detected operational event. For example, the messages and data objects can convey information pertaining to the operational event. As another example, policy inputs enable the ASCCI middleware 94 to determine whether it should adjust network resources on the network side or computing resources (and services that use those computing resources) on the SOA and grid computing infrastructures side. The policy inputs may be based on the policy lookup as was described earlier with reference to FIG. 5. Other inputs received from both sides, such as “available nodes” from the communications infrastructure, provide the ASCCI middleware 94 with information it needs to take appropriate action, i.e., effect the appropriate adjustment to resources. More specifically, in communicating with the SOA, grid computing and communications infrastructure regarding resource and service adjustments, the ASCCI middleware 94 will need to send commands (or requests) that are in the appropriate formats and populated with the information necessary to make the adjustment. That information is obtained via inputs 142, 144. Other information provided with outputs 146, 148 indicates to the infrastructures what actions to take, e.g., service startup/shutdown and bandwidth modifications, and other pertinent information.

Through the ASCCI 60, which may be implemented at the node level via the ASCCI middleware 94, the software of the SOA and grid computing infrastructures on the one side and the communications infrastructure of the MANET on the other side are effectively made aware of each other. More specifically, the SOA and grid computing infrastructures become aware of what the communications/network infrastructure must do for applications, and the communications infrastructure side is made aware of its impacts upon the applications. Simply put, the ASCCI 60 allows the applications to become “network aware” and the network to become “application aware”.

As discussed above, the ASCCI 60 (FIG. 3), implemented at the node level as the ASCCI middleware 94 (FIGS. 4-6), provides a comprehensive service-to-network approach that is adaptive in terms of services, use of grid resources and communications. It is designed to achieve objectives for a more optimal tactical command and control: usable bandwidth and network connectivity when needed; computing resources allocated and available without operator input; and high-priority tasks available when needed on key tactical nodes. SOA, MANET and grid computing infrastructures are combined and utilized by the ASCCI to match resources with operational needs. The SOA infrastructure provides pieces of the architecture at the application layer which can become “grid enabled” and resource adjustable, the grid computing infrastructure allows the applications to adjust and be adjusted. The ASCCI uses the grid computing infrastructure and the MANET communications infrastructure to adjust use of the computing resources and the network resources, respectively.

Although the adaptive services of the ASCCI have been discussed in the context of a military tactical command and control operations environment (combat or medical), other uses are contemplated. It will be appreciated that the adaptive services capability of the ASCCI described herein is also applicable to non-military network environments, e.g., governmental and civilian (such as fire, police, paramedic and other emergency responses) and even commercial. It may be particularly useful for providing medical services, particularly in areas requiring use of MANET for prioritization of software services in a mobile environment, such as disaster affected areas.

The adaptive services mechanism (that is, the ASCCI 60 of FIG. 1 and node specific ASCCI middleware 94 of FIGS. 4-6) presented herein is of particular value in dynamic environments in which resource needs for command and control are not well defined, for example, in evolving areas of operations in which future computing needs are unknown. It serves to leverage initial resources until such time as resource needs have been assessed and acquired.

All references cited herein are hereby incorporated herein by reference in their entirety.

Having described preferred embodiments which serve to illustrate various concepts, structures and techniques which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

What is claimed is:

1. A method for use by a mobile device operating in a network of mobile devices comprising:
detecting an operational event; and
adjusting utilization of resources based upon requirements of the operational event.

2. The method of claim 1 wherein the resources comprise a first type of resources comprising network resources and a second type of resources comprising computing resources.

3. The method of claim 2, wherein adjusting comprises using a policy to determine whether utilization of a resource of the first type or the second type is to be adjusted.

4. The method of claim 2, wherein adjusting comprises using a policy to determine conditions under which utilization of both the first type of resources and second type of resources are to be adjusted and the order in which the utilization of the first type of resources and the second type of resources are to be adjusted.

5. The method of claim 2 wherein the computing resources comprise grid-enabled computing resources.

6. The method of claim 2 wherein the network resources comprise mobile ad hoc network (MANET) resources when the network is configured as a MANET.

7. The method of claim 6 wherein the MANET network resources comprise tactical edge MANET resources when the network is configured as a military tactical edge MANET.

8. A system comprising:
a mobile user node to connect to other mobile nodes in a network; and
an adaptive services component, in the mobile user node, to adjust utilization of resources based upon requirements of an operational event when an operational event is detected.

9. The system of claim 8 wherein the resources comprise a first type of resources comprising network resources and a second type of resources comprising computing resources

10. The system of claim 9 furthering comprising services including first services, residing in the mobile use node, detect the operational event and notify the adaptive services component that adjustments to the utilization of resources are necessary.

11. The system of claim 10 wherein the services further comprise second services to provide policy usable by the adaptive services component in adjusting utilization of resources.

12. The system of claim 9 wherein the computing resources comprise grid-enabled computing resources.

13. The system of claim 9 wherein the network resources comprise mobile ad hoc network (MANET) resources when the network is configured as a MANET.

14. The system of claim 13 wherein the MANET network resources comprise tactical edge MANET resources when the network is configured as a tactical edge MANET.

15. The system of claim 8 wherein the mobile node is configured with software applications, a communications protocols software and middleware between the software applications and the communications protocols software, wherein the middleware comprises a grid computing middleware and the adaptive services component.

16. The system of claim 15, wherein the software applications include a an SOA platform and SOA-platform based software.

17. A network comprising:
a MANET having nodes and provided with infrastructures to manage resources associated with the nodes; and
an adaptive services infrastructure responsive to operational events and configured to utilize the infrastructures to adjust utilization of resources according to requirements of the operational events.

18. The network of claim 17 wherein the resources comprise computing resources and network resources, and wherein the infrastructures comprise an SOA infrastructure to manage services used by applications of the nodes, a grid computing infrastructure to manage the computing resources and a MANET communications infrastructure to manage the network resources.

19. The network of claim 18 wherein the MANET is a military tactical edge MANET deployed in a military command and control network environment and the applications comprise command and control applications.
